(19) United States
(12) Patent Application Publication
(10) Pub. No.: US 2003/0036941 A1
(43) Pub. Date: Feb. 20, 2003

(54) System and method for scheduling multiple meetings on an electronic calendar

(75) Inventors: Michael A. Leska, Endicott, NY (US); Gilford F. Martino, Endwell, NY (US); Frank J. Robyck JR., Endwell, NY (US)

Correspondence Address: IBM Corp, Dept. 917, 3605 Highway 52 North, Rochester, MN, 55901-7829, US

(73) Assignee: International Business Machines Corporation, Armonk, NY (US)

(21) Appl. No.: 09/932,606

(22) Filed: Aug. 17, 2001

(51) Int. Cl. G06F 17/60

(52) U.S. Cl. 705/9

(57) ABSTRACT

A system and method for scheduling multiple meetings, with separate meetings for each of a plurality of individuals. A user defines a meeting template that specifies when he or she is available by identifying such information as days worked, work day starting and ending times, lunch and break times, and previously scheduled appointments. The user then sends the meeting template to individuals with whom he or she wishes to schedule a meeting. The recipients of the meeting template select an available meeting time that is also acceptable for them, and the meeting template is dynamically updated to reflect this meeting. The other individual recipients of the template and meeting request are then blocked from also selecting this scheduled meeting time for their meetings with the user.

### BACKGROUND OF THE INVENTION

1. Technical Field of the Invention

This invention pertains to dynamic creation of electronic calendars. More particularly, it pertains to the scheduling of multiple meetings using a shared calendar template.

2. Background Art

Lotus Notes and other calendaring and E-mail suites or programs provide capability for scheduling meetings. Such are used, for example, by managers and team leaders for scheduling meetings with their respective employees or team members. A user may select a meeting time which is then sent to the prospective attendees, each of which may accept, decline or ignore the invitation. The user is notified and if the invitation is accepted, the attendee's calendar is updated to reflect the meeting. When several meetings are required with individuals, the user may send out a notice of times available for the meetings. As each recipient of the notice responds, the users calendar is updated to reflect the new meeting time. When the calendar is pretty full, it is difficult to specify the available times, and each recipient needs first to verify that the user's calendar has not been updated since the invitation to remove the time preferred by the recipient before responding to schedule a meeting at that preferred time. This in turn normally requires that the user or a secretary enter an appointment at the specified time, for both parties, and sometimes to send out a meeting notice.

It is an object of the invention to provide an improved system and method for scheduling meetings on electronic calendars.

It is a further object of the invention to provide an improved system and method for scheduling non-conflicting meetings of a first individual with a plurality of other individuals.

It is a further object of the invention to provide a one-click system and method for calendar creation and maintenance for scheduling a plurality of non-conflicting meetings with a primary person.

It is a further object of the invention to provide an improved system and method for calendaring a plurality of prospective attendees into an available time slot on the calendar of a primary person.

### SUMMARY OF THE INVENTION

A system and method for scheduling a plurality of meetings with a plurality of invitee users on a calendar of a primary user. The primary user creates a primary appointment template identifying available meeting times and sends the primary appointment template to the plurality of invitee users. Each invitee user selects an available time from said primary appointment template to schedule a meeting with said primary user.

In accordance with an aspect of the invention, there is provided a computer program product configured to be operable for scheduling a plurality of meetings with a plurality of invitee users on a calendar of a primary user creating a primary appointment template identifying available meeting times, sending the primary appointment template to the plurality of invitee users in a note inviting and each invitee user to select an available time from the primary appointment template to schedule a meeting with the primary user.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a schematic representation of the creation of an appointment template, or calendar object, in accordance with an exemplary embodiment of the invention.

FIG. 2 is a schematic representation of the creation of an appointment and of maintenance of appointment templates and calendars in accordance with an exemplary embodiment of the invention.

FIG. 3 is a schematic representation of the creation of a calendar and templates overlay display in accordance with an exemplary embodiment of the invention.

FIG. 4 is a process flow diagram illustrating the creation and maintenance of a plurality of calendar objects in accordance with an exemplary embodiment of the invention.

### DETAILED DESCRIPTION OF THE INVENTION

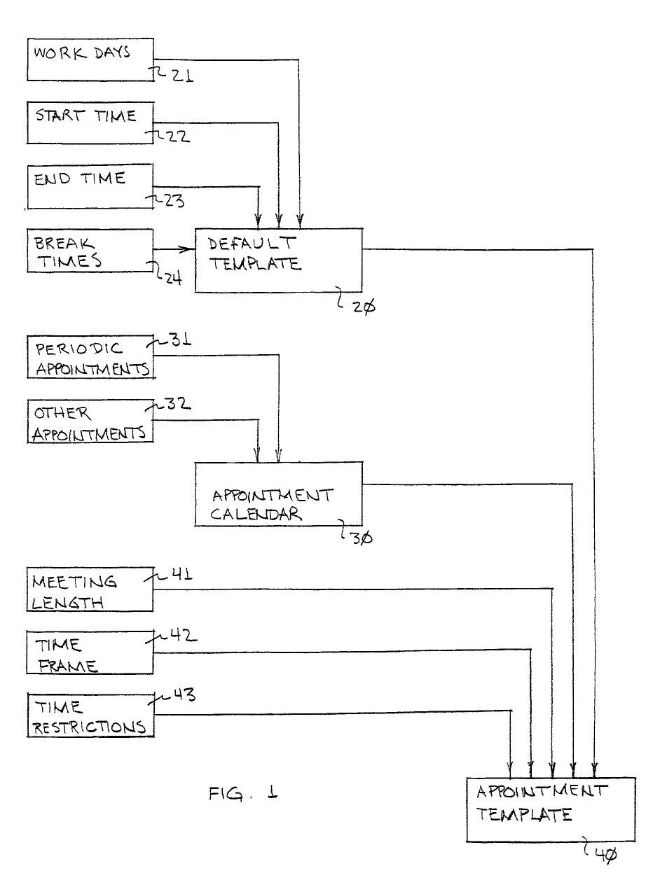

Referring to FIG. 1, in accordance with an exemplary embodiment of the invention, a system and method is provided for scheduling multiple meetings, with separate meetings for each of a plurality of individuals. A user defines an appointment template, or calendar object, 40 that specifies when he or she is available by identifying such information as days worked 21, work day starting and ending times 22, 23, lunch and break times 24, and previously scheduled appointments 31, 32. The user then sends the meeting template 40 to individuals with whom he or she wishes to schedule a meeting. The recipients of the meeting template select an available meeting time that is also acceptable for them, and the meeting template 40 is dynamically updated to reflect this meeting. The other individuals are then blocked from also selecting this scheduled meeting time for their meetings with the user.

In accordance with an exemplary embodiment of the invention, meeting template object 40 is created using Java to define a 2-dimensional array, or a vector of objects. This vector represents each day for some specified time duration 42, such as one month. Each object in the vector is associated with an attribute, such as current meetings scheduled 31, 32, free time, lunch time, start time 22, end time 23, and so forth. Construction of template 40 is best done within an existing calendar software application, such as Lotus Notes, which includes in its create menu an entry for creating meeting template object 40 and upon selection initializes template 40. An additional pop-up window may be provided for prompting the user to enter duration of the meeting desired 41, who needs to be scheduled, the time frame, or range of time 42 within which meetings must be completed, and any time restrictions 43. Upon receiving this information, meeting template object 40 displays in graphical format the blocks of time available. Each of these blocks is capable of selection by prospective attendees. The user is then prompted to distribute the meeting request, which contains the graphical form of meeting template object 40. The meeting template object 40 preferably resides on a primary server, so that when slots are selected by prospective attendees, the block selected may be disabled for selection by other prospective attendees.

In accordance with a preferred embodiment of the invention, when a prospective attendee (pa1) receives a note with a meeting request, he opens the note to see the primary persons meeting template object (ppmto) in graphical format. This ppmto is the most recent copy, for it is retrieved from the primary server when pa1 selects to open the note. An E-mail tool is used to recognize that the note with the meeting requests contains a ppmto, and retrieves the pa1 calendar for the time frame specified in the ppmto. The E-mail application then creates a meeting template object for pa1, using the same parameters or attributes provided in the ppmto, and then merges the two meeting template objects to form a merged template object for pa1 (pa1mto) showing the available time slots remaining for selection by the first invitee (pa1). In an exemplary embodiment, object pa1mto displays available time slots in one color and, possibly, time slots when pa1 is busy and primary person (pp) has available time in a second color.

A prospective attendee (pa1) selects a time slot, or block, by clicking on it. That slot may be configured as a button, selection of which causes the action of sending an accept meeting request message to the primary server and updating the ppmto in pa1's note and on the primary server. The primary person (pp) responds with an acknowledgment back to pa1. This slot (or time block) may be a hyperlink, which links the user to a web page on a primary server which would then disable this slot in the ppmto 40 and update the primary person's calendar 30.

The ppmto's distributed to the prospective attendees may be updated as follows. First, the primary server may be contacted to update the distributed ppmto's whenever any prospective attendee opens his copy of the ppmto. Second, the primary server may update changes to the ppmto at the server, then broadcast the latest changes to any prospective attendee that has not signed up for a meeting. This may also be done from the primary person's calendar, immediately after any of the prospective attendees have signed up for a meeting.

In the event that a prospective attendee signs up for a time slot that has just been selected by someone else, the primary server responds to the prospective attendee that the time slot is not available, updates the server copy of the ppmto 40, and continues as before. This is why the primary person must send an acknowledgment to each prospective attendee signing up for a time slot.

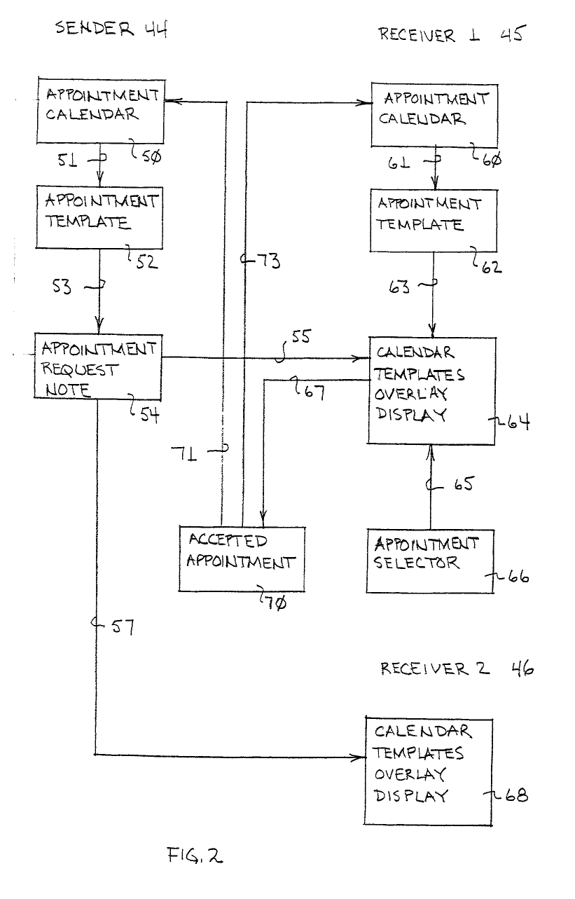

Referring to FIG. 2 in connection with FIG. 1, in accordance with a further exemplary embodiment of the invention, a first individual 44, such as a manager or team leader desiring to schedule individual meetings with a plurality of other individuals 45, 46, first creates a default meeting template 20. The default meeting template 20 may be initialized with busy default settings including the time that the manager is at lunch 24, typical starting and ending times 22, 23, and work days 21. This default meeting template 20 may also be initialized with or alternatively merged with regularly scheduled, periodic appointments 31 and other appointments 32 from appointment calendar 50 (similar to calendar 30, FIG. 1) to form appointment template 52 (similar to appointment template 40, FIG. 1).

A meeting template or calendar object 52 for a particular series of meetings may then be created from the default template 20 and appointment calendar 30 by specifying specific start and end date 42, meeting length 41, other currently scheduled appointments 31, 32, and any other time restrictions 43 (such as, use the profile in Notes, or start after 9 AM, or end before 5 PM, or no Fridays, or some such combination of restrictions). Alternatively, the meeting or appointment template 52 may be created by a user without reference to any default template 20 or further without reference to any appointment calendar 30.

When this appointment template 52 is created, the primary user, or sender, 44 loads it or a pointer to it at the primary server, to a note 54 which includes a request to select a meeting time that is convenient, which note is then sent to each individual invitee 45, 46 with each possible block of time for the requested appointment highlighted in a manner indicating when the meeting could occur.

When an individual invitee 45 receives the note containing the invitation or request and meeting template in note 54, the individual selects a meeting time from the template by selecting a preferred block of time, such as by clicking a mouse positioned to that block of time in a graphical representation of template 52. Alternatively, the preferred block of time may be selected automatically. Thus, appointment selector 66 may be an individual user or a logic element executing on behalf of that user 45. Upon selecting the preferred block of time, the meeting is automatically entered into requester and invitee calendars 50, 60 and, possibly, a meeting notification generated to each attendee.

When a next individual 46 selects a meeting time in the same manner, the meeting template 52 is updated with the new meeting added or an error generated if the time selected has previously been selected. Alternatively, with each scheduled meeting added or deleted, the meeting template 52 could be updated and transmitted to the recipients of the previous request and template 54.

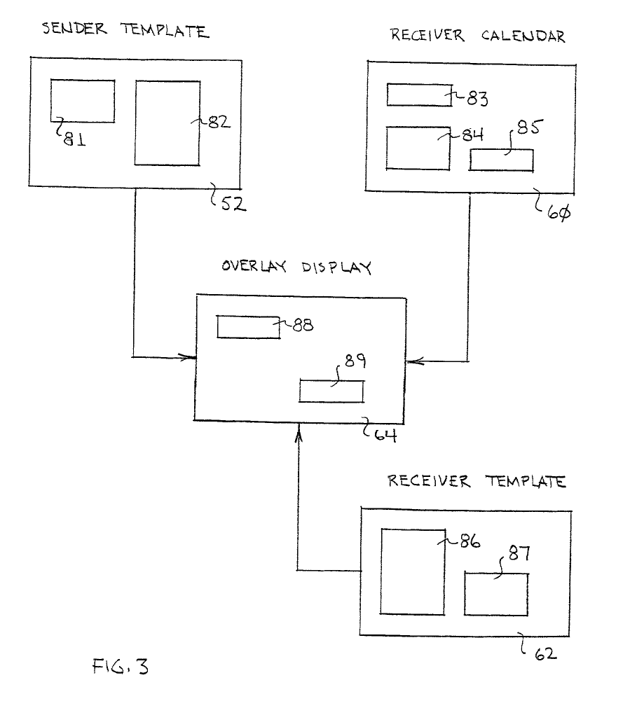

In accordance with yet another embodiment of the invention, a first user 44 requesting a meeting with each of a plurality of other users 45, 46, sends to each other user a first meeting template 52. Each other user also maintains an appointment template 62 (for first user 45, and a similar template for second user 46 and others) indicating times available for appointments. As is illustrated in FIG. 3, the first meeting template 52, showing available time blocks 81, 82 may be overlaid on the other user's template 62, showing available time blocks 83-35, and template 62, showing time blocks 86 and 87, so that only blocks of time 88, 89 available on both templates 52 and 62, and calendar 60 will be displayed in overlay display 64 for user or automatic selection of a preferred appointment time.

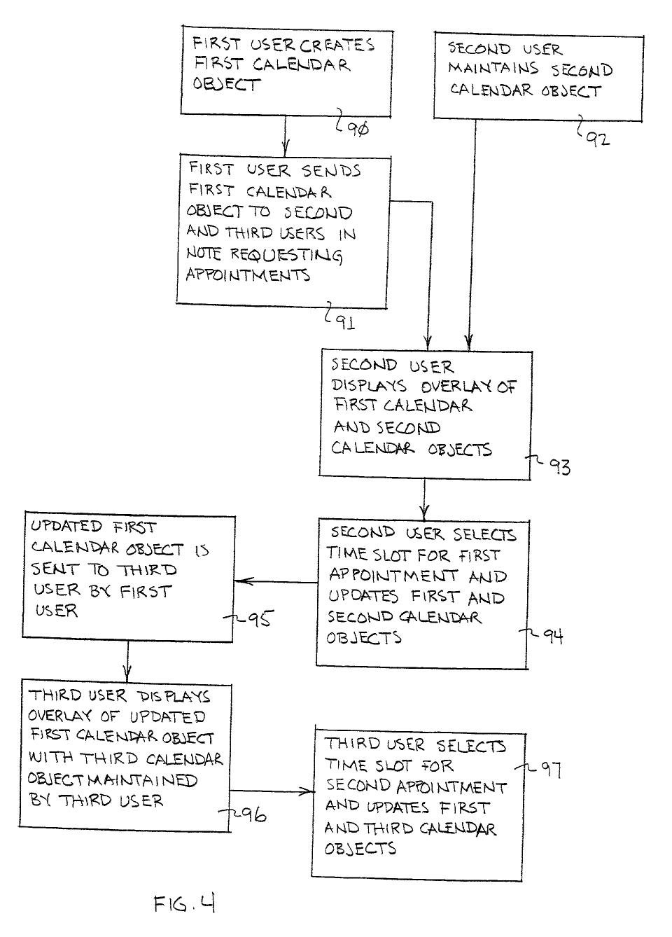

Referring to FIG. 4, an alternative embodiment of the method of the invention includes in step 90 the creation of a first calendar object 52 by a first user, and in step 92 the maintenance of a second calendar object 62 by a second user. (Step 96 provides for similar maintenance of a third calendar object by a third user.) In step 91, first user sends the first calendar object 52 to the second and third users in a note 54 requesting an appointment with each. This step may be executed with respect to any number of individuals 45, 46 with whom the first user requires a separate meeting. In step 93, the first receiving user 45 displays an overlay 64 of first calendar and second calendar objects 52 and 62, and in step 94 selects a time slot and updates the first and second calendar objects accordingly. In step 95, the updated first calendar object 52 is sent to a third user 46 by the first user 44, who then in step 96 and 97 displays and selects from an overlay of objects a preferred meeting time, and updates the first and third calendar objects. Steps 95-97 are repeated for each individual or user with which the first user desires a meeting appointment.

In accordance with a further embodiment of the invention, a primary person (sender) desires to schedule a meeting with a plurality of attendees at the same time. In this case, the prospective attendees (receivers) can select multiple meeting times, until there is one time selected by everyone. The primary person then sends out a meeting confirmation note and the calendars of the prospective attendees are appropriately updated.

### ADVANTAGES OVER THE PRIOR ART

It is an advantage of the invention that there is provided an improved system and method for scheduling meetings on electronic calendars.

It is a further advantage of the invention that there is provided an improved system and method for scheduling non-conflicting meetings of a first individual with a plurality of other individuals.

It is a further advantage of the invention that there is provided a one-click system and method for calendar creation and maintenance for scheduling a plurality of non-conflicting meetings with a primary person.

It is a further advantage of the invention that there is provided an improved system and method for calendaring a plurality of prospective attendees into an available time slot on the calendar of a primary person.

### Alternative Embodiments

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. A method for scheduling a plurality of meetings with a plurality of invitee users on a calendar of a primary user, comprising the steps of:
said primary user creating a primary appointment template identifying available meeting times;
sending said primary appointment template to said plurality of invitee users; and
each said invitee user selecting an available time from said primary appointment template to schedule a meeting with said primary user.

2. The method of claim 1, further comprising the steps of identifying available meeting times on said primary appointment template by specifying days worked, workday start and ending times, and by blocking out previously scheduled appointments and break times on said calendar of said primary user.

3. The method of claim 2, further comprising the step of creating said primary appointment template by merging a default template and said calendar with primary user selected meeting length, time frame and time restriction objects, said default template defining said days worked, said workday start and ending times, and said break times, and said calendar defining said previously scheduled appointments.

4. The method of claim 2, further comprising the steps responsive to a first invitee user selecting a first available time of dynamically scheduling a first meeting at said first available time, entering said first meeting into said primary appointment template, notifying said primary user and said first invitee user of said first meeting, and blocking further invitee users from scheduling a second meeting conflicting with said first available time.

5. The method of claim 2, further comprising the steps of said plurality of invitee users iteratively selecting multiple meeting times from said primary appointment template until there is one time selected by each said invitee user, and notifying said primary user and said plurality of invitee users of said one time.

6. The method of claim 4, further comprising the steps of creating said primary appointment template as a two dimensional array of objects, each said object representing a block of time and an attribute.

7. The method of claim 6, said attribute being selected from the group of attributes including current scheduled meeting, free time, start time, end time, and break time.

8. The method of claim 7, further comprising the step of presenting to said primary user a menu entry and associated pop-up windows for creating said primary appointment template.

9. The method of claim 8, further comprising the step of distributing said primary appointment template as a graphic object including time slots available for selection by prospective meeting attendees.

10. The method of claim 2, further comprising the step of:
responsive to said first invitee user receiving a note with a meeting request from said primary user, said first invitee user opening said note and displaying said primary appointment template in graphical format, said primary appointment template being retrieved from a primary server upon said note being opened.

11. The method of claim 10, further comprising the step of:
upon said first invitee user selecting an available meeting time, updating said primary appointment template to block further invitee users from selecting said meeting time selected by said first invitee user.

12. The method of claim 11, further comprising the step of:
responsive to said first invitee user opening said note containing said primary appointment template, creating from said primary appointment template and a calendar object for said first invitee user a first merged appointment template object from which said first invitee user may select said available meeting time.

13. The method of claim 12, further comprising the step of configuring time blocks of available meeting times in said first merged appointment template object as buttons, selection of a button resulting in the step of sending an accept meeting request message to said primary server.

14. The method of claim 13, each said time block being a hyperlink linking said first invitee user to a web page on said primary server for disabling said time block from further selection in said primary appointment template and updating a calendar object for said primary user at said primary server.

15. The method of claim 4, further comprising the step of distributing an updated primary appointment template to said further invitee users responsive to said first invitee user selecting said first available time.

16. The method of claim 4, further comprising the step of distributing an updated primary appointment template to a second invitee user responsive to said second invitee user opening a copy of said note containing said primary meeting template.

17. System for scheduling a plurality of meetings with a plurality of individuals on a calendar of a primary user, comprising:
a primary appointment template object for storing a plurality of available time slots in said calendar of said primary user;
a primary server for storing said first appointment template object;
a plurality of calendar template objects, a said calendar template object for each of a plurality of invitee users;
a calendar tool for distributing said first appointment template object to a plurality of said invitee users;
each said plurality of said invitee users having a selector for selecting an available time slot from said first appointment template object at said primary server.

18. The system of claim 17, said primary appointment template object comprising a default template and appointment calendar merged with primary user selected meeting length, time frame and time restrictions objects.

19. The system of claim 18, said default template specifying work days, start, end and break times and said appointment calendar specifying periodic and other appointments on the appointment calendar of said primary user.

20. A program storage device readable by a machine, tangibly embodying a program of instructions executable by a machine to perform method steps for scheduling a plurality of meetings with a plurality of invitee users on a calendar of a primary user, said method steps comprising:
said primary user creating a primary appointment template identifying available meeting times;
sending said primary appointment template to said plurality of invitee users; and
each said invitee user selecting an available time from said primary appointment template to schedule a meeting with said primary user.

21. The program storage device of claim 20, said method steps further comprising the steps of identifying available meeting times on said primary appointment template by specifying days worked, workday start and ending times, and by blocking out previously scheduled appointments and break times on said calendar of said primary user.

22. The program storage device of claim 21, said method steps further comprising the step of creating said primary appointment template by merging a default template and said calendar with primary user selected meeting length, time frame and time restriction objects, said default template defining said days worked, said workday start and ending times, and said break times, and said calendar defining said previously scheduled appointments.

23. The program storage device of claim 21, said method steps further comprising the steps responsive to a first invitee user selecting a first available time of dynamically scheduling a first meeting at said first available time, entering said first meeting into said primary appointment template, notifying said primary user and said first invitee user of said first meeting, and blocking further invitee users from scheduling a second meeting conflicting with said first available time.

24. The program storage device of claim 21, said method steps further comprising the steps of said plurality of invitee users iteratively selecting multiple meeting times from said primary appointment template until there is one time selected by each said invitee user, and notifying said primary user and said plurality of invitee users of said one time.

25. The program storage device of claim 23, said method steps further comprising the steps of creating said primary appointment template as a two dimensional array of objects, each said object representing a block of time and an attribute.

26. The program storage device of claim 25, said method steps said attribute being selected from the group of attributes including current scheduled meeting, free time, start time, end time, and break time.

27. The program storage device of claim 26, said method steps further comprising the step of presenting to said primary user a menu entry and associated pop-up windows for creating said primary appointment template.

28. The program storage device of claim 27, said method steps further comprising the step of distributing said primary appointment template as a graphic object including time slots available for selection by prospective meeting attendees.

29. The program storage device of claim 21, said method steps further comprising the step of:
responsive to said first invitee user receiving a note with a meeting request from said primary user, said first invitee user opening said note and displaying said primary appointment template in graphical format, said primary appointment template being retrieved from a primary server upon said note being opened.

30. The program storage device of claim 29, said method steps further comprising the step of:
upon said first invitee user selecting an available meeting time, updating said primary appointment template to block further invitee users from selecting said meeting time selected by said first invitee user.

31. The program storage device of claim 30, said method steps further comprising the step of:
responsive to said first invitee user opening said note containing said primary appointment template, creating from said primary appointment template and a calendar object for said first invitee user a first merged appointment template object from which said first invitee user may select said available meeting time.

32. The program storage device of claim 31, said method steps further comprising the step of configuring time blocks of available meeting times in said first merged appointment template object as buttons, selection of a button resulting in the step of sending an accept meeting request message to said primary server.

33. The program storage device of claim 32, each said time block being a hyperlink linking said first invitee user to a web page on said primary server for disabling said time block from further selection in said primary appointment template and updating a calendar object for said primary user at said primary server.

34. The program storage device of claim 23, said method steps further comprising the step of distributing an updated primary appointment template to said further invitee users responsive to said first invitee user selecting said first available time.

35. The program storage device of claim 23, said method steps further comprising the step of distributing an updated primary appointment template to a second invitee user responsive to said second invitee user opening a copy of said note containing said primary meeting template.

36. A computer program product or computer program element for scheduling a plurality of meetings with a plurality of invitee users on a calendar of a primary user according to method steps comprising:
creating a primary appointment template identifying available meeting times on the calendar of said primary user;
sending said primary appointment template to said plurality of invitee users; and
each said invitee user selecting an available time from said primary appointment template to schedule a meeting with said primary user.
